(19) United States
(12) Patent Application Publication
(10) Pub. No.: US 2023/0028365 A1
(43) Pub. Date: Jan. 26, 2023

(54) AQUEOUS RECHARGEABLE ZINC BATTERIES

(71) Applicants: Northwestern University, Evanston, IL (US); King Abdulaziz City for Science and Technology, Riyadh (SA); NEWSOUTH INNOVATIONS PTY LIMITED, UNSW Sydney NSW (AU)

(72) Inventors: James Fraser Stoddart, Evanston, IL (US); Kwan Woo Nam, Evanston, IL (US); Dongjun Kim, Waterloo NSW (AU)

(21) Appl. No.: 17/757,746

(22) PCT Filed: Dec. 21, 2020
(86) PCT No.: PCT/US2020/066368

§ 371 Date: Jun. 20, 2022

Related U.S. Application Data
(60) Provisional application No. 62/951,443, filed on Dec. 20, 2019.

(51) Int. Cl. H01M 4/60; H01M 4/62; H01M 10/36; C07F 3/06

(52) U.S. Cl. CPC H01M 4/60; C07F 3/06; H01M 4/623; H01M 4/625; H01M 10/36; H01M 2004/028

(57) ABSTRACT

Disclosed herein are aqueous rechargeable zinc batteries and cathodic materials for preparing the same. The cathodic material of these batteries comprises a redox-active triangular phenanthrenequinone-based macrocycle.

### CROSS-REFERENCE TO RELATED APPLICATIONS

This application claims benefit of priority to U.S. Pat. Application serial number 62/951,443, filed Dec. 20, 2019, the contents of which are incorporated herein by reference in its entirety.

### FIELD OF THE INVENTION

The disclosed technology is generally directed to rechargeable batteries. More particularly the technology is directed to aqueous rechargeable zinc batteries and cathodic materials for preparing the same.

### BACKGROUND OF THE INVENTION

Although lithium ion batteries (LIBs) are applied currently as a means of storing grid energy, there are limitations when it comes to applying them to large-scale energy storage systems (ESSs) in terms of cost and safety. In order to overcome the limitations of LIBs, the development of advanced battery systems is required. Among various such battery systems, aqueous rechargeable zinc batteries (ZBs) have drawn attention for use in large-scale ESSs because of their sizable theoretical specific capacity (820 mAh g⁻¹), high safety, cost, and abundance of zinc. Nevertheless, ZBs still remain a subject for investigation, as researchers search for cathode materials enabling high performance.

In ZBs, the anode often utilizes Zn metal while the efficacy with respect to capacity, voltage, rate-capability and cyclability are tailored by fine-tuning the cathode materials.^{6,7,13,14} At the early stages in the development of ZBs, inorganic cathode materials were investigated intensively.^{6-8,12} Initially, α-MnO₂ was utilized as a cathode material for aqueous rechargeable ZBs for the simple reason that its large tunnel structure is desirable for the facile diffusion of Zn²⁺ ions.¹² Subsequent investigations, however, have revealed that the α-MnO₂ cathode has low cycle-life because of Mn²⁺ dissolution in the electrolytes together with irreversible structural phase transformation. ^{15,16} Other inorganic cathode materials, such as vanadium oxide bronze, have been found^{6,14} to be more efficient with better cycling performance than α-MnO₂ in aqueous ZBs. The toxicity and the cost of vanadium-based cathodes, however, hampers^{6,14} further application for large-scale ESSs. In recent years, organic-inorganic hybrid batteries have gained considerable attention because of the synthetic availability, low cost, and light-weight of organic redox-active materials.^{11,17,18} Quinones are characterized^{11,19} by a reversible redox process and high specific capacity. The quinone-based cathodes, however, suffer from the critical limitation of undergoing dissolution during battery cycling, leading to a deterioration in battery life. As a result, there exists a need for cathode materials.

### BRIEF SUMMARY OF THE INVENTION

Described herein are aqueous rechargeable zinc batteries and cathodic materials for preparing the same. One aspect of the invention is cathodic materials comprising a macrocycle. The macrocycle may comprise a substituted or unsubstituted phenanthrenequinone unit. The macrocycle may further comprise a zinc complex. In some embodiments, the macrocycle comprises a hydrated zinc complex. The macrocycle may comprise three substituted or unsubstituted phenanthrenequinone units in a triangular arrangement. In some embodiments, the macrocycle comprises

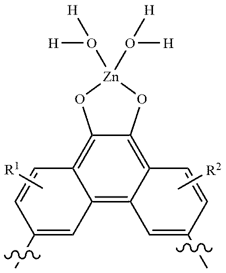

wherein R¹ and R² are independently selected from hydrogen, halogen, azide, alkyl, aralkyl, alkenyl, alkynyl, cycloalkyl, hydroxyl, alkoxyl, amino, nitro, imino, amido, carbonyl, -C(O)alkyl, carboxy, -CO2alkyl, alkylthio, sulfonyl, sulfonamido, sulfhydryl, sulfonamide, heterocyclyl, aryl, heteroaryl, —CF3, or —CN. Suitably, the macrocycle may comprise

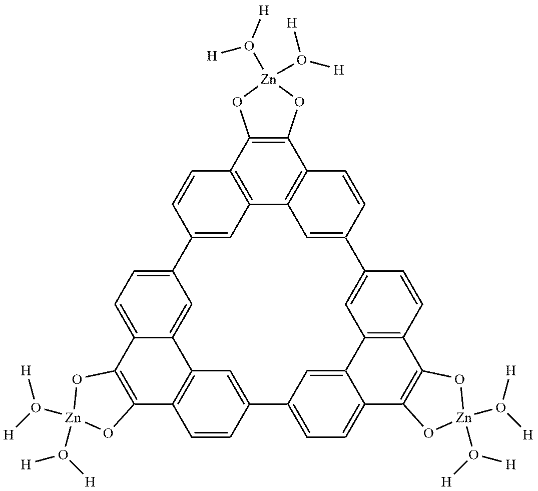

Another aspect of the invention is a cathode comprising any of the cathodic materials described herein.

Another aspect of the invention is a battery comprising any of the cathodes, cathodic materials, or macrocycles described herein and an aqueous zinc electrolyte. In some embodiments, the macrocycle comprises

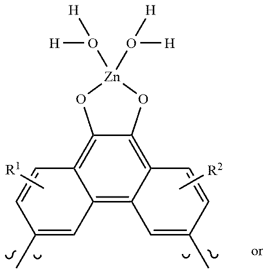

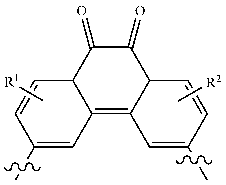

wherein R¹ and R² are independently selected from hydrogen, halogen, azide, alkyl, aralkyl, alkenyl, alkynyl, cycloalkyl, hydroxyl, alkoxyl, amino, nitro, imino, amido, carbonyl, -C(O)alkyl, carboxy, -CO₂alkyl, alkylthio, sulfonyl, sulfonamido, sulfhydryl, sulfonamide, heterocyclyl, aryl, heteroaryl, —CF₃, or —CN. Suitably, the macrocycle may comprise

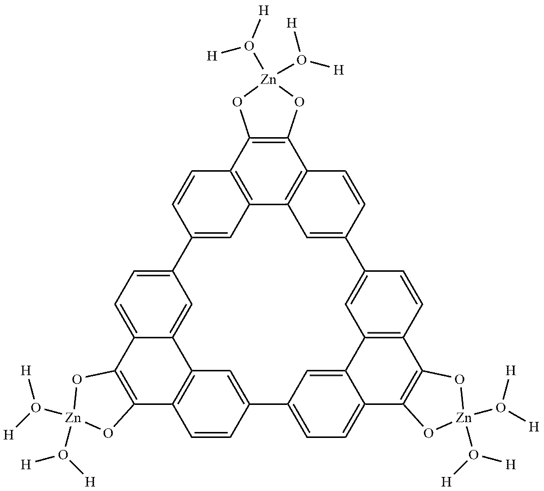

or

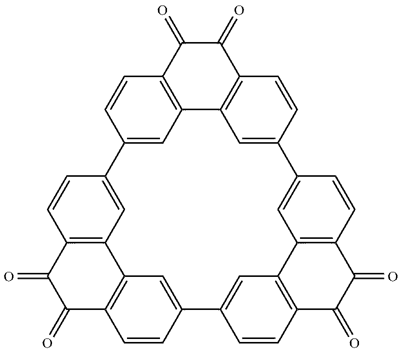 [SMILES: O=c1c(=O)c2ccc3cc2c2cc(ccc12)c1ccc2c(=O)c(=O)c4ccc(cc4c2c1)c1ccc2c(=O)c(=O)c4ccc3cc4c2c1]

In some embodiments, the electrolyte comprises Zn(CF₃SO₃)₂, Zn(CH₃SO₃)₂, ZnSO₄•xH₂O (x = 0-7), Zn(NO₃)₂•xH₂O (x = 0-6), or Zn(TFSI)₂. Suitably the concentration of Zn²⁺ in the aqueous zinc electrolyte is less than 6.0 M.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIGS. 1A-1C show Zn/PQ-Δ chemistry. (FIG. 1A) Schematic illustration of an exemplary aqueous rechargeable Zn/ PQ-Δ cell. (FIG. 1B) Structural formula of PQ-Δ. (FIG. 1C) Electrochemical redox chemistry of PQ-Δ in aqueous rechargeable ZBs.

FIGS. 2A-2D show a comparison of the electrochemical properties of PQ-Δ when using organic and aqueous electrolytes. Electrolyte: 0.25 M Zn(CF₃SO₃)₂ in MeCN or 3 M Zn(CF₃SO₃)₂ in DI H₂O. (FIG. 2A) Discharge-charge voltage profiles and cycling performance of PQ-Δ at current densities of (FIG. 2B) 30 mA g⁻¹ and (FIG. 2C) 150 mA g⁻¹. (FIG. 2D) EIS Spectra profiles of PQ-Δ when using organic and aqueous electrolytes, respectively

FIGS. 3A-3D show confirmation of H₂O insertion into PQ-Δ. (FIG. 3A) Relative energy values depend on the volume and the number (Inset) of solvents. (FIG. 3B) TGA profiles of PQ-Δ electrodes in the pristine and discharged states. (FIG. 3C) FT-IR of PQ-Δ during the discharge-charge process. (FIG. 3D) Relative energy values of Zn-coordinated PQ molecules depend on the H₂O molecules. Blue, red, grey, and white represent Zn, O, C, and H, respectively

FIGS. 4A-4D show analysis of the redox center for PQ-Δ. (FIG. 4A) FT-IR Spectra of PQ-Δ during the discharge-charge process. Ex situ XPS spectra of (FIG. 4B) Zn 2p and (FIG. 4C) O 1s. (FIG. 4D) Charge density increment for PQ-Δ after discharge. Blue, red, grey, and white represent Zn, O, C, and H, respectively.

FIG. 5 shows MALDI-TOF Mass spectra of PQ-Δ, measured with a-cyano-4-hydroxycinnamic acid (CHCA) as a matrix.

FIG. 6 shows PXRD patterns of the PQ-Δ electrode in the pristine, 1^{st} and 30^{th} fully discharged/charged states at a rate of 30 mA g⁻¹, respectively.

FIGS. 7A-7C show ex situ XPS survey spectra of PQ-Δ at (FIG. 7A) pristine, (FIG. 7B) discharged, and (FIG. 7C) charged electrodes.

FIG. 8 shows a cyclic voltammogram of PQ-Δ. Cyclic voltammetry (CV) was performed using a coin-type cell, two electrode configuration with active electrode composed of PQ-Δ : acetylene black : PVDF = 6 : 3 : 1.

FIGS. 9A-9B show discharge-charge of AQ-PQ-Δ with using aqueous electrolytes at a current density of (FIG. 9A) 30 mA g⁻¹ and (FIG. 9B) 150 mA g⁻¹. The discharge-charge process was performed using a coin-type cell, two-electrode configuration with the active electrode composed of PQ-Δ : acetylene black : PVDF = 6 : 3 : 1. Electrolyte: 3 M Zn(CF₃SO₃)₂ in DI H₂O.

### DETAILED DESCRIPTION OF THE INVENTION

Disclosed herein are aqueous rechargeable zinc batteries. The cathodic material of these batteries comprises a redox-active phenanthrenequinone-based macrocycle. These cathodic materials address the critical limitation of undergoing dissolution during battery cycling. Notably, Zn²⁺ ions, together with H₂O molecules, can be inserted into the cathodic material. As a consequence, the interfacial resistance between the cathode and electrolytes is decreased. Without wishing to be bound by theory, it is believed that the low interfacial resistance can be attributed mainly to decreasing the desolvation energy penalty as a result of the insertion of hydrated Zn²⁺ ions in the cathodic material. The combined effects of the insertion of hydrated Zn²⁺ ions and the robust triangular structure serves to achieve a large reversible capacity along with excellent cycle-life.

The macrocycles disclosed herein, may be used to prepare active materials, cathodes, and batteries. Rigid macrocycles are cyclic macromolecules or a cyclic portions of macromolecules that are constrained against large-amplitude conformational rearrangement. The macrocycle comprises a substituted or unsubstituted phenanthrenequinone (PQ) unit. The PQ unit comprises a diradical having a formula

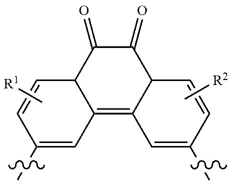

The PQ unit may be substituted at one or more ring positions with, for example, halogen, azide, alkyl, aralkyl, alkenyl, alkynyl, cycloalkyl, hydroxyl, alkoxyl, amino, nitro, sulfhydryl, imino, amido, carboxylic acid, -C(O)alkyl, -CO₂alkyl, carbonyl, carboxyl, alkylthio, sulfonyl, sulfonamido, sulfonamide, ketone, aldehyde, ester, heterocyclyl, aryl or heteroaryl moieties, —CF₃, —CN, or the like. In certain embodiments, the aromatic ring is substituted at one or more ring positions with halogen, alkyl, hydroxyl, or alkoxyl. In certain other embodiments, the aromatic ring is not substituted. R¹ and R² may be independently selected from hydrogen, halogen, azide, alkyl, aralkyl, alkenyl, alkynyl, cycloalkyl, hydroxyl, alkoxyl, amino, nitro, sulfhydryl, imino, amido, carboxylic acid, -C(O)alkyl, -CO₂alkyl, carbonyl, carboxyl, alkylthio, sulfonyl, sulfonamido, sulfonamide, ketone, aldehyde, ester, heterocyclyl, aryl or heteroaryl moieties, —CF₃, or —CN. Suitably, the macrocycle comprises three PQ units arranged in a triangular arrangement.

Suitably, any or all of the substituted or unsubstituted PQ units described above may be complexed with zinc center. The zinc center may be chelated by one or both of the oxygen atoms of the PQ unit. In some embodiments, the zinc center is hydrated and the Zn atom is chelated to one or more oxygen atoms of the aqueous electrolyte. In some embodiments, the redox-active macrocycle may be hydrated with 0, 1, 2, 3, 4, 5, or 6 water molecules. This allows for the preparation of zinc containing complexes such as

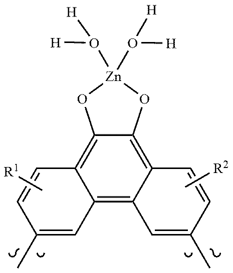

The PQ units described herein may be a portion of a redox-active macrocyclic compound in which the redox-active units are covalently linked together to form a triangular constitution. The exemplary triangular macrocycle, phenanthrenequinone triangle (PQ-Δ)

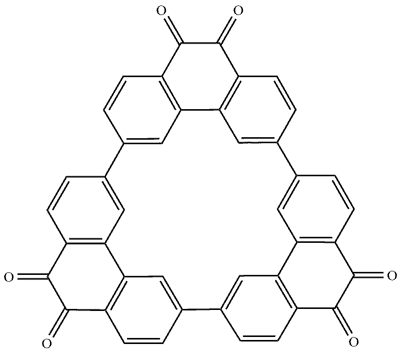 [SMILES: O=c1c(=O)c2ccc3cc2c2cc(ccc12)c1ccc2c(=O)c(=O)c4ccc(cc4c2c1)c1ccc2c(=O)c(=O)c4ccc3cc4c2c1]

was prepared and used in the Examples that follow. PQ-Δ and its preparation have been previously described. [Metal-Free Phenanthrenequinone Cyclotrimer as an Effective Heterogeneous Catalyst. J. Am. Chem. Soc. 2009, 131, 11296-11297] An exemplary method for preparing PQ- Δ is shown in following scheme.

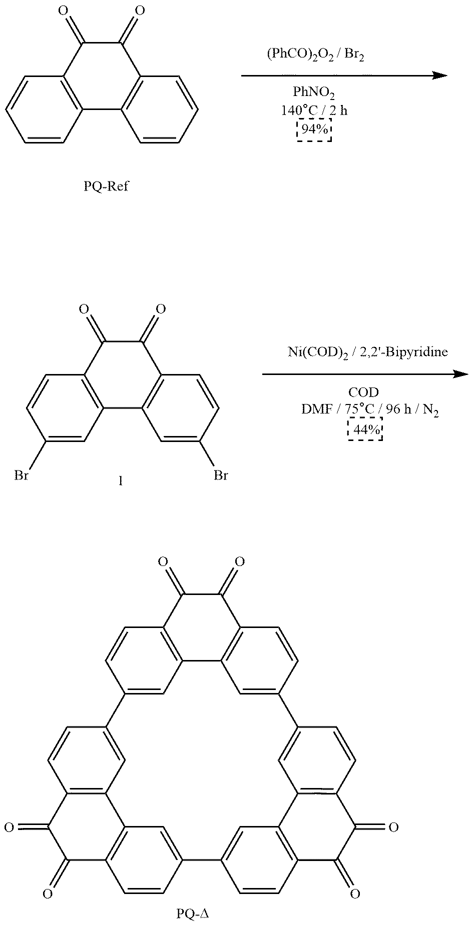

Synthesis Scheme 1 | Synthesis of 3,6-dibromophenanthrenequinone and phenanthrenequinone triangle (PQ-Δ).

In certain embodiments, the macrocycle comprises a hydrated zinc complex. An Exemplary hydrated zinc complex is PQ-Δ•3Zn-xH₂O, where x is an integer from 1-6. Suitably, macrocycle may be PQ-Δ•3Zn-6H₂O

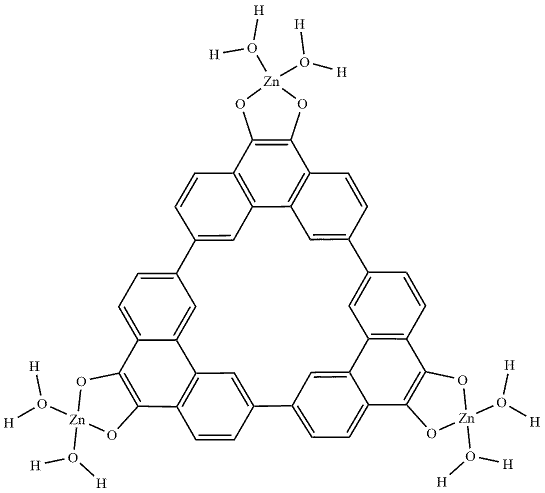

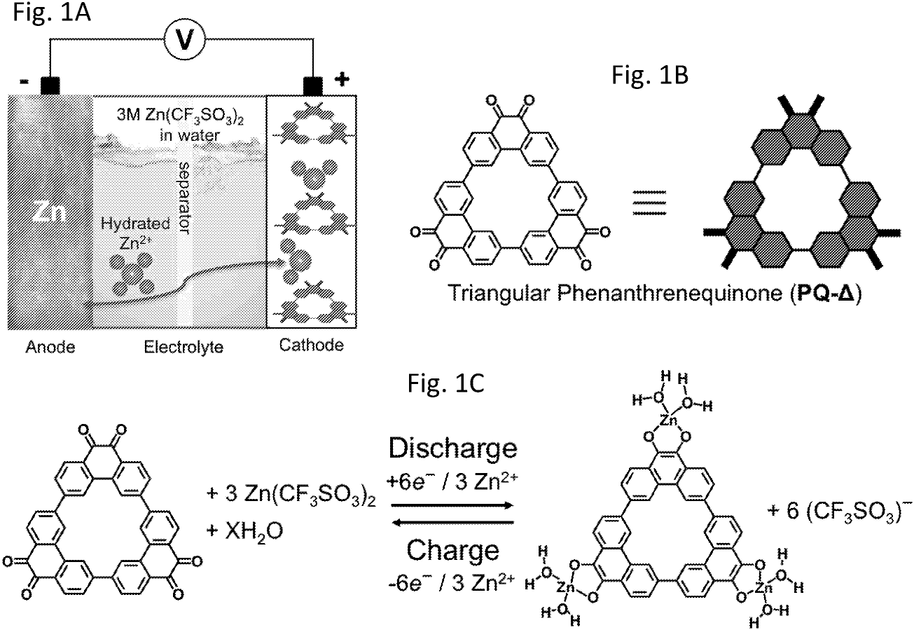

The electrochemical redox chemistry of PQ-Δ in aqueous rechargeable ZBs is shown in FIG. 1C.

Active materials, cathodes, and batteries described may comprise any of the rigid macrocycles described here, including, without limitation PQ-Δ or PQ-Δ•3Zn-xH₂O, wherein x is an integer from 1-6.

The active materials may further comprise a binder material and/or an electron-conducting material. In some embodiments, the cathodic material further comprises a solvent.

In some embodiments, the macrocycle is 1-90 wt% (e.g., 1 wt%, 2 wt%, 3 wt%, 4 wt%, 5 wt%, 6 wt%, 7 wt%, 8 wt%, 9 wt%, 10 wt%, 11 wt%, 12 wt%, 13 wt%, 14 wt%, 15 wt%, 20 wt%, 25 wt%, 30 wt%, 35 wt%, 40 wt%, 45 wt%, 50 wt%, 55 wt%, 60 wt%, 65 wt%, 70 wt%, 75 wt%, 80 wt%, 85 wt%, 90 wt%, or any ranges therebetween) of the cathodic material.

In some embodiments, the binder material comprises a polymer selected from the group consisting of: styrene-butadiene rubber (SBR); polyvinylidene fluoride (PVDF); polytetrafluoroethylene (PTFE); copolymer of tetrafluoroethylene, hexafluoropropylene, and vinylidene fluoride; copolymer of hexafluoropropylene and vinylidene fluoride; copolymer of tetrafluoroethylene and perfluorinated vinyl ether; methyl cellulose; carboxymethyl cellulose; hydroxymethyl cellulose; hydroxyethyl cellulose; hydroxypropylcellulose; carboxymethylhydroxyethyl cellulose; nitrocellulose; colloidal silica; and combinations thereof. In some embodiments, binder material comprises PVDF. In some embodiments, the binder material is 1-25 wt% (e.g., 1 wt%, 2 wt%, 3 wt%, 4 wt%, 5 wt%, 6 wt%, 7 wt%, 8 wt%, 9 wt%, 10 wt%, 11 wt%, 12 wt%, 13 wt%, 14 wt%, 15 wt%, 20 wt%, 25 wt%, or any ranges therebetween) of the cathodic material. In some embodiments, the binder material is 5-15 wt% of the cathode material.

In some embodiments, the solvent comprises N-methyl-pyrrolidone (NMP).

In some embodiments, the electron-conducting additive is a carbon or graphitic material. In some embodiments, the carbon or graphitic material is selected from the list consisting of: a graphite, a carbon black, a graphene, and a carbon nanotube. In some embodiments, the carbon or graphitic material is a graphite selected from the group consisting of: graphite worms and expanded graphite. In some embodiments, the carbon or graphitic material is chemically-etched or expanded soft carbon, chemically-etched or expanded hard carbon, or exfoliated activated carbon. In some embodiments, the carbon or graphitic material is a carbon black selected from the group consisting of: acetylene black (e.g., Denka black), channel black, furnace black, lamp black thermal black, chemically-etched or expanded carbon black, and combinations thereof. In some embodiments, the carbon or graphitic material is a carbon nanotube selected from the group consisting of: chemically-etched multi-walled carbon nanotube, nitrogen-doped carbon nanotube, boron-doped carbon nanotube, chemically-doped carbon nanotube, ion-implanted carbon nanotube, and combinations thereof. In some embodiments, the electron-conducting additive comprises carbon black. In some embodiments, the electron-conducting additive is 1-99 wt% (e.g., 1 wt%, 2 wt%, 3 wt%, 4 wt%, 5 wt%, 6 wt%, 7 wt%, 8 wt%, 9 wt%, 10 wt%, 11 wt %, 12 wt%, 13 wt%, 14 wt%, 15 wt%, 20 wt%, 25 wt%, 30 wt%, 35 wt%, 40 wt%, 45 wt%, 50 wt%, 55 wt%, 60 wt%, 65 wt%, 70 wt%, 75 wt%, 80 wt%, 85 wt%, 90 wt%, 91 wt%, 92 wt%, 93 wt%, 94 wt%, 95 wt%, 96 wt%, 97 wt%, 98 wt%, 99 wt%, or any ranges therebetween) of the cathode material. In some embodiments, the electron-conducting additive is 5-85 wt% of the cathode material.

In some embodiments, the cathodic material is present as a slurry. In some embodiments, the slurry comprises a solid content of 40-80% 40 wt%, 45 wt%, 50 wt%, 55 wt%, 60 wt%, 65 wt%, 70 wt%, 75 wt%, 80 wt%, or any ranges there between).

In some embodiments, the cathodic material is dried (e.g., solvent evaporated out of a slurry). In some embodiments, the cathodic material is dried under increased heat (e.g., above room temperature (e.g., 40° C., 50° C., 60° C., 70° C., 80° C., 90° C., 100° C., 110° C., 120° C., 130° C., 140° C., 150° C.,), reduced pressure (e.g., below atmospheric pressure, under vacuum), etc. In some embodiments, provided herein are cathodes comprising a cathode material described herein. In some embodiments, a cathode further comprises a foil substrate. In some embodiments, the foil substrate is an aluminum foil substrate. In some embodiments, a slurry comprising the cathode material is coated onto the foil substrate and dried.

Batteries comprising a cathode are described herein. In some embodiments, the battery described herein is rechargeable. Also provided herein are methods of storing energy within a batter described herein.

The battery may further comprise an anode. In some embodiments, an anode comprises zinc or other zinc-based active material. Suitably the anode may further comprise one or more of a binder material; an electron-conducting additive; and a substrate. In some embodiments, an anode further comprises a solvent. In some embodiments, the binder material, electron-conducting additive, and/or solvent of the anode are selected from the binder materials, electron-conducting additives, and/or solvents described herein for use in cathodes.

In some embodiments, a battery further comprises a separator. In some embodiments, the separator comprises polypropylene (PP), polyethylene (PE), or a combination of layers thereof.

The battery may further comprises an electrolyte material. The electrolyte within the electrochemical cell will be tailored to the particular application and components within the electrochemical cell. An advantage of the present technology is the use of multivalent Zn charge carriers for the preparation of the rechargeable batteries described herein. Suitably, the multivalent cationic charge carrier may be selected from Zn²⁺. Suitable electrolytes include, without limitation, Zn(CF₃SO₃)₂, Zn(CH₃SO₃)₂, ZnSO₄•xH₂O (x = 0-7), Zn(NO₃)₂•xH₂O (x = 0-6), and Zn(TFSI)₂. Suitably the electrolyte is an aqueous electrolyte. In some embodiments, the concentration of the Zn²⁺ is in the electrolyte is less than 6.0 M. Suitably, the concentration of Zn²⁺ is from 0.5 - 5.5 M, 1.0 - 5.5 M, 1.5 - 4.5 M, or 2.0 - 4.0 M.

As demonstrated in the Examples, batteries comprising PQ-Δ as a cathodic material for aqueous rechargeable ZBs may be prepared (FIG. 1A). The Example exhibits a reversible capacity of 225 mAh g⁻¹ at a rate of 30 mA g⁻¹. At a higher scan rate of 150 mA g⁻¹, the reversible capacity remains 210 mAh g⁻¹, and this capacity is sustained across more than 500 cycles without showing any decrease. Based on controlled experiments and density functional theory (DFT) calculations, it is believed that such high is performance for PQ-Δ cathodic materials can be attributed to a decrease in the desolvation energy by the hydrated Zn²⁺ ions, as well as the rigid structure of the PQ-Δ . PQ coordinates to (CP*)₂Zn and that the complex can undergo a reversible redox process. In addition, DFT calculations on this phenanthrenedione-based organozinc complex have revealed that the lowest unoccupied molecular orbitals (LUMOs), which are primarily π*-antibonding orbitals associated with the dione, are significantly lower in energy than the free diones. In this context, the redox process occurs on the dione moieties without any contribution to the redox process from the coordinated Zn²⁺ ions. Furthermore, the π-conjugation in the PQ-Δ can increase the electron delocalization between the PQ units’ reduced forms, the radical anion (PQ^{•-}) and dianion (PQ²⁻) units, offering additional stability, and a full six-electron reduced state can be accessed. In addition to this macrocyclic effect, in an aqueous based electrolyte system, the co-insertion of H₂O molecules with divalent carrier ions can be helpful in decreasing the desolvation energy, as well as the Coulombic repulsion, at the electrode-electrolyte interface by the hydrated carrier ions. As a result of these properties, macrocycles comprising a substituted or unsubstituted phenanthrenequinone unit allow for high performance and enhanced stability with repeated charging and discharging.

### Definitions

As used herein, an asterisk “*” or a plus sign “+” may be used to designate the point of attachment for any radical group or substituent group.

The term “alkyl” as contemplated herein includes a straight-chain or branched alkyl radical in all of its isomeric forms, such as a straight or branched group of 1-12, 1-10, or 1-6 carbon atoms, referred to herein as C₁-C₁₂ alkyl, C₁-C₁₀-alkyl, and C₁-C₆-alkyl, respectively.

The term “haloalkyl” refers to an alkyl group that is substituted with at least one halogen. For example, —CH₂F, —CHF₂, —CF₃, —CH₂CF₃, —CF₂CF₃, and the like

The term “heteroalkyl” as used herein refers to an “alkyl” group in which at least one carbon atom has been replaced with a heteroatom (e.g., an O, N, or S atom). One type of heteroalkyl group is an “alkoxyl” group

The term “alkenyl” as used herein refers to an unsaturated straight or branched hydrocarbon having at least one carbon-carbon double bond, such as a straight or branched group of 2-12, 2-10, or 2-6 carbon atoms, referred to herein as C₂-C₁₂-alkenyl, C₂-C₁₀-alkenyl, and C₂-C₆-alkenyl, respectively

The term “alkynyl” as used herein refers to an unsaturated straight or branched hydrocarbon having at least one carbon-carbon triple bond, such as a straight or branched group of 2-12, 2-10, or 2-6 carbon atoms, referred to herein as C2-C12-alkynyl, C2-C10-alkynyl, and C2-C6-alkynyl, respectively

The term “cycloalkyl” refers to a monovalent saturated cyclic, bicyclic, or bridged cyclic (e.g., adamantyl) hydrocarbon group of 3-12, 3-8, 4-8, or 4-6 carbons, referred to herein, e.g., as “C₄-₈-cycloalkyl,” derived from a cycloalkane. Unless specified otherwise, cycloalkyl groups are optionally substituted at one or more ring positions with, for example, alkanoyl, alkoxy, alkyl, haloalkyl, alkenyl, alkynyl, amido, amidino, amino, aryl, arylalkyl, azido, carbamate, carbonate, carboxy, cyano, cycloalkyl, ester, ether, formyl, halogen, haloalkyl, heteroaryl, heterocyclyl, hydroxyl, imino, ketone, nitro, phosphate, phosphonato, phosphinato, sulfate, sulfide, sulfonamido, sulfonyl or thiocarbonyl. In certain embodiments, the cycloalkyl group is not substituted, i.e., it is unsubstituted.

The term “partially unsaturated carbocyclyl” refers to a monovalent cyclic hydrocarbon that contains at least one double bond between ring atoms where at least one ring of the carbocyclyl is not aromatic. The partially unsaturated carbocyclyl may be characterized according to the number oring carbon atoms. For example, the partially unsaturated carbocyclyl may contain 5-14, 5-12, 5-8, or 5-6 ring carbon atoms, and accordingly be referred to as a C₅—C₁₄, C₅—C₁₂, C₅—C₈, or C₅-C₆ membered partially unsaturated carbocyclyl, respectively. The partially unsaturated carbocyclyl may be in the form of a monocyclic carbocycle, bicyclic carbocycle, tricyclic carbocycle, bridged carbocycle, spirocyclic carbocycle, or other carbocyclic ring system. Exemplary partially unsaturated carbocyclyl groups include cycloalkenyl groups and bicyclic carbocyclyl groups that are partially unsaturated. Unless specified otherwise, partially unsaturated carbocyclyl groups are optionally substituted at one or more ring positions with, for example, alkanoyl, alkoxy, alkyl, haloalkyl, alkenyl, alkynyl, amido, amidino, amino, aryl, arylalkyl, azido, carbamate, carbonate, carboxy, cyano, cycloalkyl, ester, ether, formyl, halogen, haloalkyl, heteroaryl, heterocyclyl, hydroxyl, imino, ketone, nitro, phosphate, phosphonato, phosphinato, sulfate, sulfide, sulfonamido, sulfonyl or thiocarbonyl. In certain embodiments, the partially unsaturated carbocyclyl is not substituted, i.e., it is unsubstituted.

The term “aryl” is art-recognized and refers to a carbocyclic aromatic group. Representative aryl groups include phenyl, naphthyl, anthracenyl, and the like. The term “aryl” includes polycyclic ring systems having two or more carbocyclic rings in which two or more carbons are common to two adjoining rings (the rings are “fused rings”) wherein at least one of the rings is aromatic and, e.g., the other ring(s) may be cycloalkyls, cycloalkenyls, cycloalkynyls, and/or aryls. Unless specified otherwise, the aromatic ring may be substituted at one or more ring positions with, for example, halogen, azide, alkyl, aralkyl, alkenyl, alkynyl, cycloalkyl, hydroxyl, alkoxyl, amino, nitro, sulfhydryl, imino, amido, carboxylic acid, -C(O)alkyl, -CO₂alkyl, carbonyl, carboxyl, alkylthio, sulfonyl, sulfonamido, sulfonamide, ketone, aldehyde, ester, heterocyclyl, aryl or heteroaryl moieties, —CF₃, —CN, or the like. In certain embodiments, the aromatic ring is substituted at one or more ring positions with halogen, alkyl, hydroxyl, or alkoxyl. In certain other embodiments, the aromatic ring is not substituted, i.e., it is unsubstituted. In certain embodiments, the aryl group is a 6-10 membered ring structure.

The terms “heterocyclyl” and “heterocyclic group” are art-recognized and refer to saturated, partially unsaturated, or aromatic 3- to 10-membered ring structures, alternatively 3-to 7-membered rings, whose ring structures include one to four heteroatoms, such as nitrogen, oxygen, and sulfur. The number of ring atoms in the heterocyclyl group can be specified using Cx—Cx nomenclature where x is an integer specifying the number of ring atoms. For example, a C₃—C₇ heterocyclyl group refers to a saturated or partially unsaturated 3- to 7-membered ring structure containing one to four heteroatoms, such as nitrogen, oxygen, and sulfur. The designation “C₃—C₇” indicates that the heterocyclic ring contains a total of from 3 to 7 ring atoms, inclusive of any heteroatoms that occupy a ring atom position.

The terms “amine” and “amino” are art-recognized and refer to both unsubstituted and substituted amines, wherein substituents may include, for example, alkyl, cycloalkyl, heterocyclyl, alkenyl, and aryl.

The terms “alkoxyl” or “alkoxy” are art-recognized and refer to an alkyl group, as defined above, having an oxygen radical attached thereto. Representative alkoxyl groups include methoxy, ethoxy, tert-butoxy and the like.

An “ether” is two hydrocarbons covalently linked by an oxygen. Accordingly, the substituent of an alkyl that renders that alkyl an ether is or resembles an alkoxyl, such as may be represented by one of -O-alkyl, -O-alkenyl, -O-alkynyl, and the like.

An “epoxide” is a cyclic ether with a three-atom ring typically include two carbon atoms and whose shape approximates an isosceles triangle. Epoxides can be formed by oxidation of a double bound where the carbon atoms of the double bond form an epoxide with an oxygen atom.

The term “carbonyl” as used herein refers to the radical —C(O)—.

The term “carboxamido” as used herein refers to the radical —C(O)NRR', where R and R′ may be the same or different. R and R′ may be independently alkyl, aryl, arylalkyl, cycloalkyl, formyl, haloalkyl, heteroaryl, or heterocyclyl.

The term “carboxy” as used herein refers to the radical —COOH or its corresponding salts, e.g. —COONa, etc.

The term “amide” or “amido” as used herein refers to a radical of the form —R¹C(O)N(R²)—, —R¹C(O)N(R²) R³—, —C(O)N R² R³, or —C(O)NH₂, wherein R¹, R² and R³ are each independently alkoxy, alkyl, alkenyl, alkynyl, amide, amino, aryl, arylalkyl, carbamate, cycloalkyl, ester, ether, formyl, halogen, haloalkyl, heteroaryl, heterocyclyl, hydrogen, hydroxyl, ketone, or nitro.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

### Results and Discussion

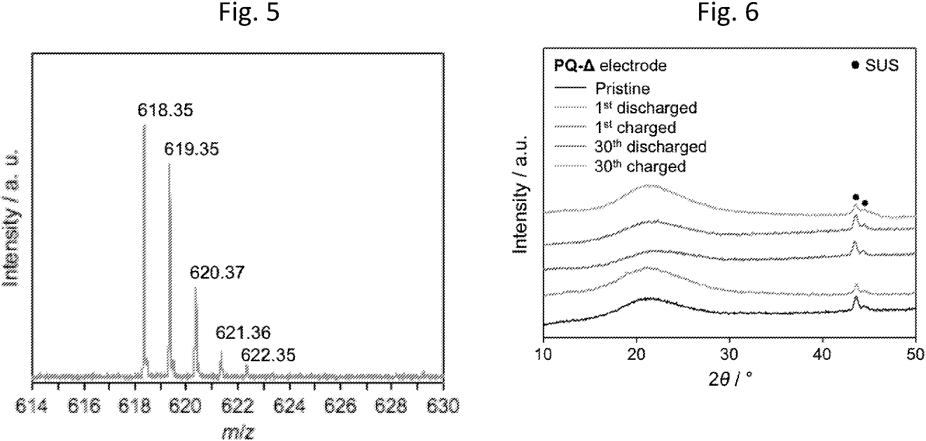

Electrochemical testing of PQ-Δ using organic and aqueous electrolytes. PQ-Δ with a layered structure was prepared (FIG. 1B) according to a previously reported procedure. [ Zhang, J.; Wang, X.; Su, Q.; Zhi, L.; Thomas, A.; Feng, X.; Su, D. S.; Schlögl, R.; Müllen, K. Metal-Free Phenanthrenequinone Cyclotrimer as an Effective Heterogeneous Catalyst. J. Am. Chem. Soc. 2009, 131, 11296-11297.] The constitution of the compound was confirmed by matrix-assisted laser desorption/ionization-time of flight (MALDI-TOF) (FIG. 5) and powder X-ray diffraction (FIG. 6). Acetonitrile (MeCN) and H₂O are common solvents in organic and aqueous batteries devices, respectively. All of the electrochemical measurements were performed either in aqueous (3M Zn(CF₃SO₃)₂ in DI H₂O̅) or under organic (0.25 M Zn(CF₃SO₃)₂ in MeCN) solvent conditions.In ZBs, the Coulombic efficiency (CE) of the Zn(CF₃SO₃)₂ electrolyte in aqueous media gradually reaches 100% as a result of the bulky nature of the CF₃SO₃⁻ anions, facilitating Zn²⁺ transport and charge transfer. [Zhang, N.; Cheng, F.; Liu, Y.; Zhao, Q.; Lei, K.; Chen, C.; Liu, X.; Chen, J. Cation-Deficient Spinel ZnMn₂O₄ Cathode in Zn(CF₃SO₃)₂ Electrolyte for Rechargeable Aqueous Zn-ion Battery. J. Am. Chem. Soc. 2016, 138, 12894-12901.] It is noteworthy that the intrinsic cavity of PQ-Δ, combined with its insoluble nature in aqueous media, offer the advantages of enhanced ion transport throughout the electroactive materials, as well as overcoming the dissolution issues often encountered in organic batteries. Hereafter, all of the electrochemical measurements were performed using coin cells with a two-electrode configuration, and detailed experimental conditions are described below. In addition, unless indicated otherwise, the potential values are based on the Zn/Zn²⁺ (-0.76 V vs. NHE) redox couple.

Initially, cyclic voltammetry (CV) measurements were performed and the redox behavior between the aqueous and the organic electrolytes was compared. The CV data (FIG. 8) of aqueous PQ-Δ (AQ-PQ-Δ) cell exhibited single oxidation and reduction peaks at 1.05 and 0.63 V, respectively. In organic cells utilizing MeCN as solvent (MeCN—PQ—Δ), we observed a lower intensity and broadening of redox peaks around 1.17 and 0.32 V, which is reportedly on account of high desolvation energy^{13,24} and Coulombic repulsion²⁵ at the interface between the cathode electrode and organic electrolyte.

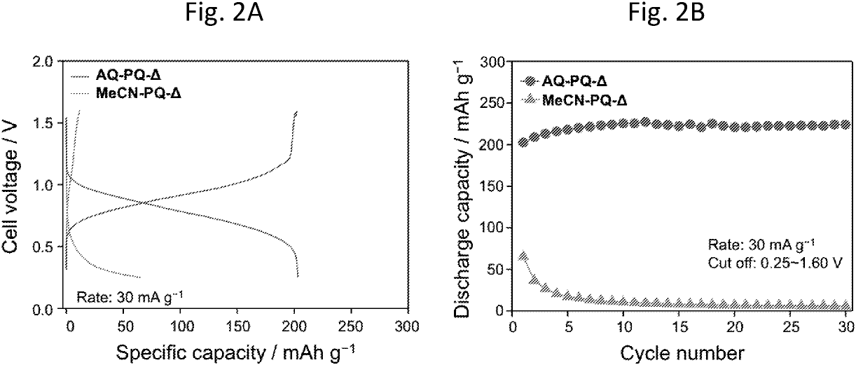

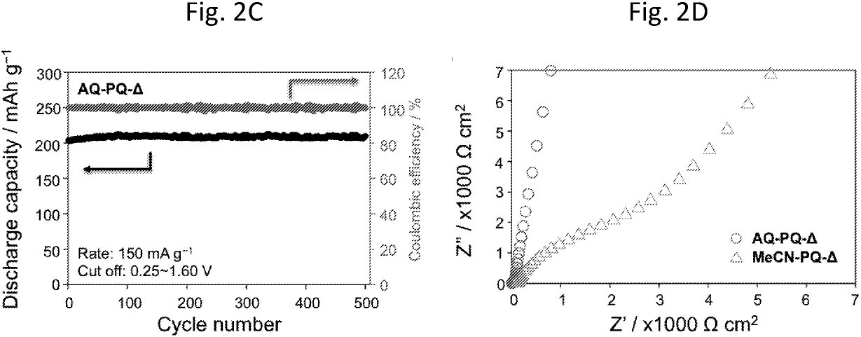

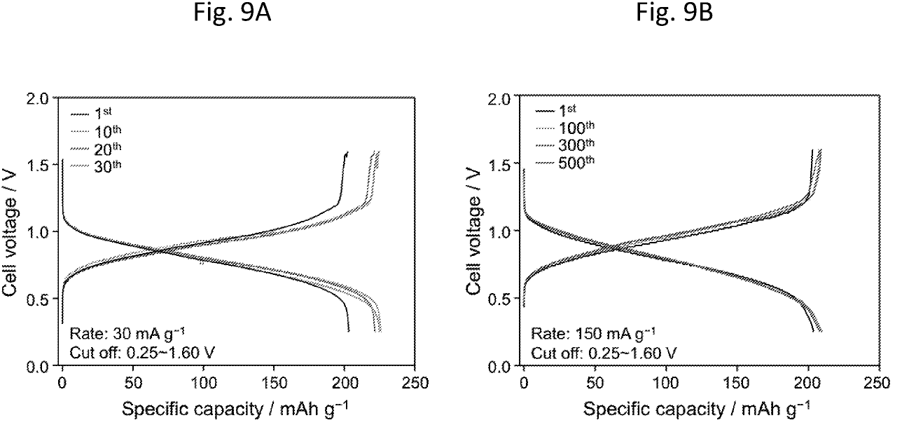

After confirming the redox behavior by CV analysis, we carried out galvanostatic measurements in the voltage range between 0.25 and 1.60 V. At a current rate of 30 mA g⁻¹, AQ-PQ-Δ exhibited (FIG. 2A) a single-plateau voltage profile around 0.84 V with a specific capacity of 203 mAh g⁻¹ and a Coulombic efficiency of 99.6%. On the other hand, the MeCN—PQ—Δ cell exhibited (FIG. 2A) a substantially smaller capacity of 65 mAh g⁻¹, along with a low Coulombic efficiency of 17.9%. Notably, the experimental specific capacity value for AQ-PQ-Δ corresponds (FIG. 2A) to the acceptance of six-electrons per PQ-Δ molecule (FIG. 1C), indicating the utilization of two electrons per phenanthrenequinone (PQ) molecule. It appears that PQ-Δ is reduced fully to the dianionic state in each PQ units (PQ-Δ⁶⁻) and interacts with three zinc dictations (PQ-Δ—Zn₃), an observation which has not been previously reported.¹⁸ Recent investigations²³ have led to the report of the crystal structure of (Cp*)₂Zn(C₁₄H₈O₂), which displays a fully reversible redox process behavior, indicative of the favorable coordination of Zn²⁺ dications with the dione functional groups. Additional galvanostatic cycling measurements, carried out at a current rate of 30 mA g⁻¹, confirmed that AQ-PQ-Δ features (FIG. 2B and FIG. 9A) extremely stable cycling behavior, preserving 100% of the initial capacity over 30 cycles without any loss. Even when the current rate was increased five-fold to 150 mA g⁻¹, the AQ-PQ-Δ maintained (FIG. 2C and FIG. 9Bb) 99.9% of the saturated capacity (210 mAh g⁻¹) after 500 cycles, suggesting the robustness of PQ-Δ as an electrode-active material. On the other hand, MeCN—PQ—Δ exhibited (FIG. 2B) a limited capacity of 65 mAh g⁻¹ and failed to achieve good cycling performance. Taken together, the CV and galvanostatic results indicate that there is an association between the electrolyte and electrochemical performance. In this regard, the electrochemical impedance spectroscopy (EIS) provides additional critical information relating to interfacial resistance. The EIS spectra confirmed (FIG. 2D) that the interfacial resistance between the PQ-Δ electrode and electrolytes corresponds to 40 and 3000 Ω cm² for AQ-PQ-Δ and MeCN—PQ—Δ, respectively. Our initial findings indicate that the intercalation of Zn²⁺ dications into PQ-Δ in the organic electrolyte may be restricted on account of the high interfacial resistance between the electrode and the electrolyte.

Effects of co-insertion of H₂O with Zn²⁺ ions. In order to rationalize the significant electrochemical differences between the aqueous and the organic environments, we investigated the insertion process of Zn²⁺ ions from the electrolyte into PQ-Δ in both aqueous and MeCN electrolytes. Previous Zn and Mg battery investigations have confirmed^{13,24,28} that the low interfacial resistance in aqueous batteries is associated with two factors involving the co-insertion of H₂O with divalent carrier ions: they are (i) the charge-screening effect, indicating that the co-insertion of H₂O with carrier ions in the host structures can effectively shield divalent charges and (ii) the decrease of the desolvation energy associated with the facile hydration of the carrier ion (Zn²⁺). In another words, the hydrated carrier ions are not required to detach fully from the H₂O molecules when inserting into the host cathode. By means of the charge-screening effect, insertion of the hydrated form of the divalent cations, instead of the bare cations, lowers substantially the Coulombic repulsion at the electrode-electrolyte interface during the intercalation process. In addition, because of the small size of the hydrated carrier ions, they can insert in the host cathode without detaching fully from the solvated ions, thus decreasing effectively the desolvation-energy penalty at the electrode-electrolyte interface. Conversely, the high interfacial resistance within the environment of the organic electrolytes suggests that co-insertion of MeCN is not feasible because of the weaker coordinating nature of MeCN compared with H₂O molecules.

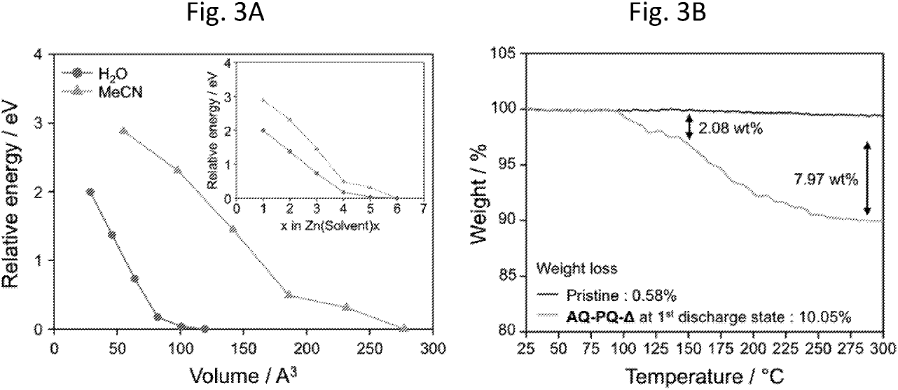

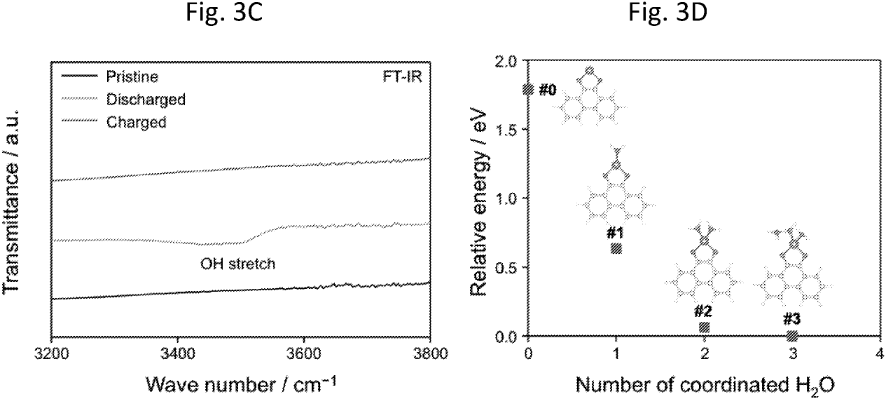

In an attempt to decipher the role of the solvent in the increase in performance of aqueous ZBs, we conducted DFT calculations in order to investigate the desolvation-energy penalty. The results have been plotted (FIG. 3A) versus the size of the Zn-coordination complex, which is required to intercalate into the PQ-Δ superstructure. In both the Zn(H₂0)ₓ and Zn(MeCN)ₓ complexes, the desolvation energy increases (inset of FIG. 3A) gradually from x = 6 to x = 4, and even more steeply upon further desolvation. Overall, the desolvation energy for the same coordination number is not much different comparing the aqueous and organic environments: rather, it is prominent that the difference in the desolvation energies depends on the size of the Zn-coordination complex. For example, to permit the carrier-ion complexes to fit into PQ-Δ pores having volumes of around 100 Å³, Zn(H₂O)₅ and Zn(MeCN)₂ complexes are required (FIG. 3A), and the costs of desolvation are 0.04 and 2.89 eV, respectively, within the aqueous and MeCN electrolytes. In a recent investigation wherein PQ-Δ was used as the electrode for aluminum batteries,¹⁸ it was confirmed that the A1³⁺ cations were inserted into a complex form of (A1C1₂)⁺, which has a volume of ~66 Å³. This latter volume corresponds to the size of Zn(H₂O)₃ in the present Zn battery system, implying that, at least, the Zn(H₂O)₃ complex can be inserted into the PQ-Δ electrode. Upon discharge (reduction) in the aqueous environment, therefore, the Zn²⁺ dications require a smaller energy cost associated with removing fewer solvent molecules than does the MeCN-based electrolyte.

The most direct method of identifying the interlayered lattice water molecules within the hydrated compound is scanning transmission electron microscopy^{24,29} (STEM). Unfortunately, on account of the amorphous and carbonaceous nature of PQ-Δ, the STEM electrode sample was decomposed by the high-energy electron beam. We, therefore, resorted to a series of physical characterization techniques, along with DFT calculations, in order to identify the insertion behavior of hydrated Zn²⁺ ions during electrochemical cycling.

Firstly, we carried out thermal gravimetric analysis (TGA) on the pristine electrode as well as on the discharged one. It is worth mentioning that the evaporation temperature of H₂O varies, depending on whether the water molecules are located in the layered structure or adsorbed onto the surface. Several studies have confirmed^{30,31} that the weight loss below around 120° C. can be attributed to evaporation of the adsorbed H₂O molecules on the surface. For comparison, the weight loss in the range 120-300° C. is mainly a result of the removal of lattice water trapped between the layers.^{30,31} The TGA curves for the pristine electrode exhibit (FIG. 3B) a negligibly small weight loss of 0.58 wt% in the temperature range up to 300° C. In the case of the discharged sample, the weight losses in the ranges 90-120° C. and 120-300° C. correspond (FIG. 3B) to 2.08 and 7.97 wt%, respectively. The trend of the observed TGA results is similar to that reported^{30,31} previously for lattice water investigations. The noticeably higher weight loss in the discharged PQ-Δ electrode in the range 120-300° C. implies the possibility of the removal of the lattice water molecules from the hydrated Zn-ion (Zn²⁺—H₂O̅) complex. In other words, the TGA results confirm indirectly that the intercalating zinc exists as the Zn²⁺—H₂O complex and not as bare Zn²⁺ dications. The insertion of the Zn²⁺—H₂O complex, therefore, may contribute to the lowering of the interfacial resistance in the aqueous environment.

Secondly, we performed ex situ Fourier-transform infrared (FT-IR) spectroscopic measurements during the battery discharge-charge process in order to confirm the presence of H₂O molecules. Notably, the FT-IR spectrum for the pristine PQ-Δ electrode did not exhibit (FIG. 3C) any noticeable H₂O absorption bands, an observation which was in agreement with the TGA findings. For the discharged electrode, however, the strong vibration of the H₂O absorption band was confirmed (FIG. 3C) at around 3500 cm⁻¹, further supporting the inclusion of the Zn²⁺—H₂0 complex, throughout the cycling process. In accordance with expectations, no absorption peak associated with H₂O was observed (FIG. 3C) at the charged electrode.

Thirdly, we calculated the relative coordination energy of H₂O molecules in the presence of Zn-OTf. According to calculated (FIG. 3D) energies, the Zn²⁺ dication is at its most thermodynamically stable when coordinating two H₂O molecules at each sulfonyl group. When more than two H₂O molecules are coordinated to the Zn²⁺ dication, they dissociate spontaneously. As a consequence, fully reduced PQ-Δ⁶⁻ interacts with three Zn²⁺—H₂O complexes in their reduced states, thus forming PQ-Δ•3Zn-xH₂O. In summary, the superior electrochemical performance of the AQ-PQ-Δ can be rationalized as a combined effect with lower desolvation energy required for the Zn²⁺—H₂0 dication and charge screening during the charge/discharge process.

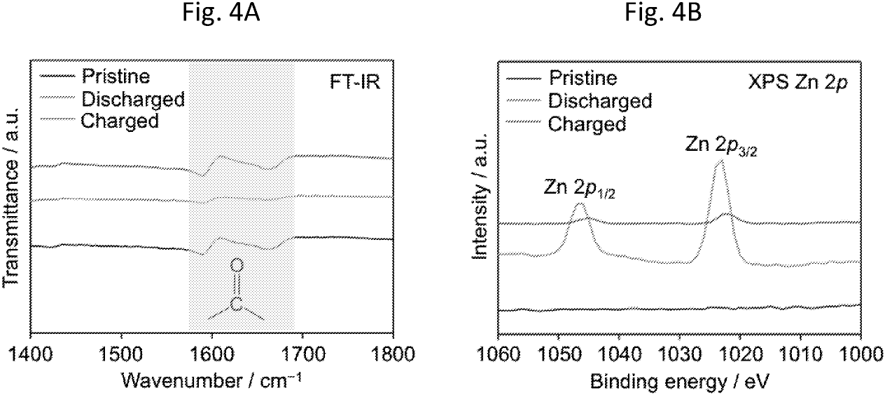

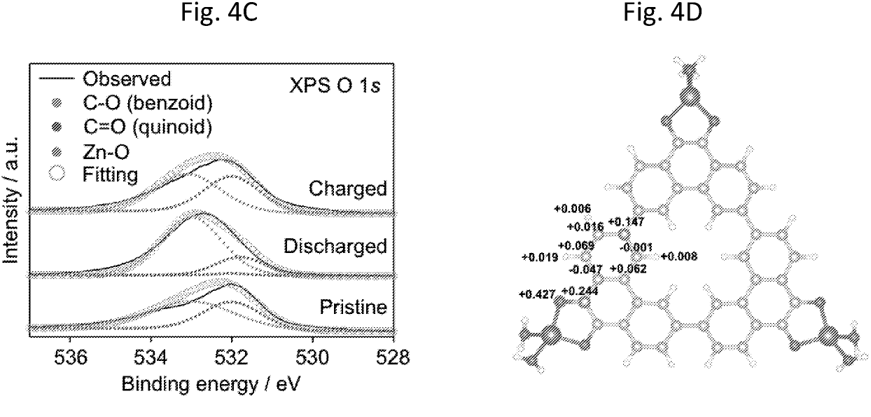

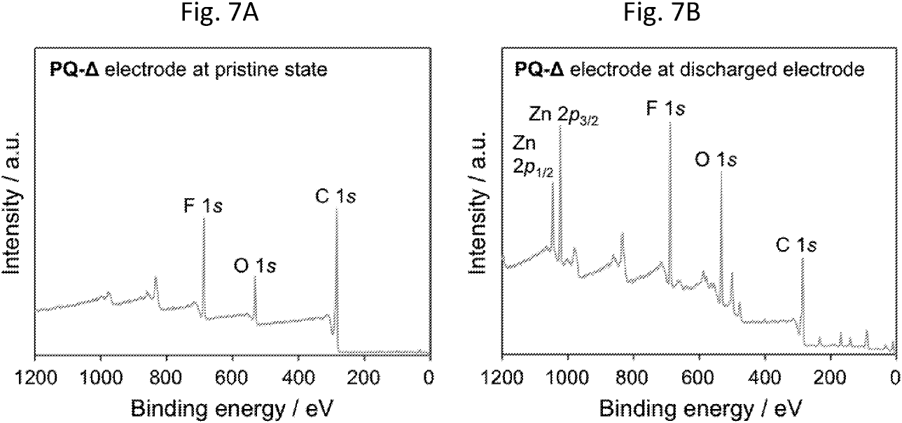

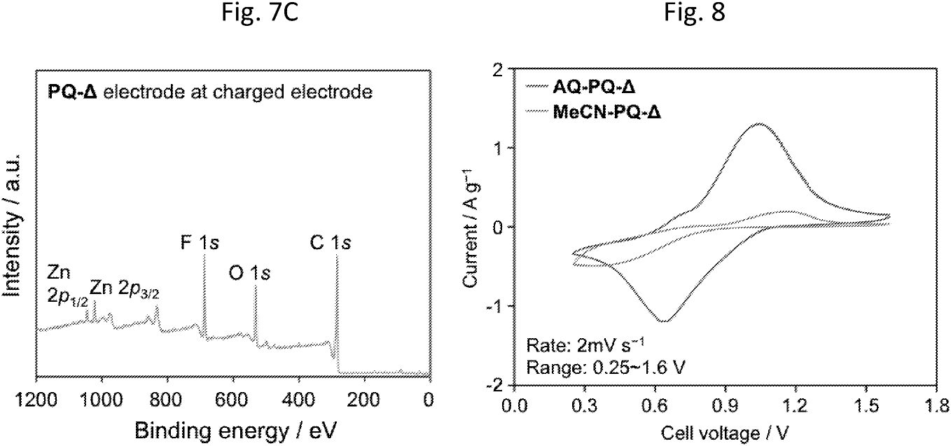

Analysis of redox center for the AQ-PQ-Δ. In order to confirm the origin of the redox reaction for AQ-PQ-Δ, ex situ FT-IR and XPS analyses were carried out during the discharge-charge process. In the FT-IR spectrum (FIG. 4A), two peaks at approximately 1670 and 1590 cm⁻¹ in the pristine electrode can be assigned¹¹ to the C=O bond stretch. After inserting Zn²⁺ ions into AQ-PQ-Δ in the fully discharged state, the peaks for the C=O bond almost disappeared (FIG. 4A). These peaks, attributable to C=O stretches, returned to their original positions at the fully charged state, while charging from the fully discharged state (FIG. 4A). These results indicate that the redox center of AQ-PQ-Δ originates from the C=O group. In order to confirm the redox center beyond any doubt, ex situ X-ray photoelectron spectroscopic (XPS) analysis was also carried out on Zn and O atoms. The Zn 2p peaks appear and disappear (FIG. 4B and FIGS. 7A-7C) at the discharged (inserting Zn²⁺ dications into AQ-PQ-Δ) and charged states (extracting Zn²⁺ dications from AQ-PQ-Δ), respectively. This observation means that the Zn²⁺ ions are inserted into and extracted from the AQ-PQ-Δ electrodes during the discharge-charge process in a reversible fashion. In addition, the quinoid peak at 532 eV shifts to a benzoid peak at 533 eV in the O 1s spectrum on going (FIG. 4C) from the pristine state to the fully discharged one. In order to specify the active sites of AQ-PQ-Δ more precisely, DFT calculations were carried out. These calculations revealed (FIG. 4D) a significant increase in the charge density on O and C atoms of the C=O group, confirming the coordination to Zn²⁺ dications. Consequently, based on all the results of FT-IR, XPS, and DFT calculations, it was verified that the C=O group of AQ-PQ-Δ is the redox center.

In summary, we present the evidence for the fact that the triangle, PQ-Δ, can be utilized as an aqueous rechargeable ZB cathode. Given the advantages of the charge-screening effect and low desolvation energy by the co-insertion of H₂O with Zn²⁺ dications, the AQ-PQ-Δ shows low interfacial resistance in the aqueous ZB system, and hence AQ-PQ-Δ can be operated at high capacity and extremely stable cycle-life during the discharge-charge process. Furthermore, DFT calculations suggest that the lowering of the desolvation energy by hydrated Zn²⁺ dications in the aqueous electrolytes allow AQ-PQ-Δ to use its active sites to the full extent. This investigation indicates that, by designing the molecular structure and controlling the coordination-environment of a divalent carrier ion, the low redox activity and cyclability of organic cathodes in divalent batteries can be improved.

### Experimental Section

Characterization. Powder X-ray diffraction (PXRD, STOE STADI-P) with Cu—Kα1 radiation was employed for crystal structure analyses by scanning in the 2θ range of 10°-50° with a scan step of 0.015°. For the characterization of PQ-Δ at different charge and discharge states, the cells were opened and rinsed with DI H₂O inside a glove box. The oxidation states of the electrodes were analyzed by X-ray photoelectron spectroscopy (XPS, Thermo Scientific ESCALAB 250Xi). Matrix-assisted laser desorption/ionization-time of flight (MALDI-TOF, Bruker AutoFlex-III), using a laser at 355 nm and α-cyano-4-hydroxycinnamic acid (CHCA) as the matrix, was conducted to confirm the mass of PQ-Δ. The structure and reversible Zn-ion coordination mechanism on the cathode were examined by ex situ Fourier-transform infrared spectroscopy (FT-IR, Bruker Tensor 37). In order to investigate the H₂O content after the discharge process, thermogravimetric analysis (TGA, Netzsch Jupiter) was performed by raising the temperature from room temperature to 300° C. at a ramping rate of 5° C. min⁻¹ under an Ar flow.

Electrochemical Tests. In order to investigate the electrochemical performance of PQ-Δ as a cathode material in aqueous rechargeable zinc batteries, coin cells with a two-electrode configuration, which comprise PQ-Δ cathodes and Zn film anode (100 µm in thickness), were assembled. The PQ-Δ electrode was first of all prepared by making a slurry containing 60 wt% PQ-Δ, 30 wt% acetylene black, and 10 wt% poly(vinylidene difluoride) (PVDF) in 1-methyl-2-pyrrolidinon (NMP). The slurry was then cast onto stainless steel (SUS 304) foil, followed by drying at 70° C. in a vacuum oven. The mass loading of the active material in each electrode was 2 mg cm⁻². The electrolytes were 3 M zinc trifluoromethanesulfonate (ZnCF₃SO₃)₂ in deionized (DI) H₂O or 0.25 M Zn(CF₃SO₃)₂ in acetonitrile (MeCN). All cells were aged for 1 h prior to any electrochemical processes to ensure good soaking of the electrolyte solution into the electrodes. The cells were cycled in the voltage range 0.25-1.60 V (vs Zn/Zn²⁺). All of the measurements were carried out at 25° C. using a battery tester (BST8-300-CST, MTI, USA). All of the galvanostatic measurements were conducted using constant current mode (no constant voltage steps). Cyclic voltammetry (CV) was carried out using coin cells with the two-electrode configuration, which comprised the PQ-Δ cathode and Zn film anode (Reference 600 potentiostat, Gamry Instruments, USA). Electrochemical impedance spectroscopy measurements were conducted with symmetric cells of the PQ-Δ in aqueous or organic electrolytes by using a Reference 600 potentiostat (Gamry Instruments, USA) in the frequency range of 0.01 Hz - 1 MHz with 10 mV in amplitude.

DFT Calculations. These calculations were performed using the B3LYP functional³² with the 6-31+g** basis set, as implemented in the Q-Chem software.³³ A universal continuum solvation model³⁴ (SM8) was considered for aqueous and MeCN electrolytes. Natural bond orbital (NBO) analysis³⁵ was employed for evaluating the charge variation. In order to estimate the number of H₂O molecules coordinating Zn²⁺ ion (FIG. 3D), the PQ monomer was used to reduce the computational cost.

### Materials and Characterization

Materials. All commercially available reagents and solvents were purchased from Sigma Aldrich and used as received without further purification. Zn film, Steel Use Stainless (SUS) film, and coin cells obtained from Goodfellow and Pred Materials, respectively. PQ-Δ was prepared according to the previous reported procedure,²⁶ washed with water and acetone respectively, and dried in air.

Characterization. For the characterization of PQ-Δ at different charge and discharge states, the cells were opened and rinsed with DI water inside a glove box. In order to obtain the water content, thermogravimetric analysis (TGA, Netzsch) was carried out from room temperature to 300° C. at a ramping rate of 5° C. min⁻¹ under an Ar flow.

Powder X-ray diffraction (PXRD, STOE STADI-P) with Cu—Kα1 radiation (λ = 1.54056 Å) was measured through transmission geometry for crystal structure analysis by scanning in the 2θ range of 10°―50° with accelerating voltage and current of 40 kV and 40 mA. For the ex situ PXRD characterization of PQ-Δ at different charge and discharge states, the cells were opened and rinsed with DI water inside a glove box.

The mass of PQ-Δ was confirmed by matrix-assisted laser desorption/ionization-time of flight (MALDI-TOF, Bruker AutoFlex-III) using laser of 355 nm and a-cyano-4-hydroxycinnamic acid (CHCA) as a matrix.

The oxidation states of electrodes were analyzed by X-ray photoelectron spectroscopy (XPS, Thermo Scientific ESCALAB 250Xi). Each sample was dried under vacuum for 1 h prior to XPS measurements. For the ex situ XPS characterization of PQ-Δ at different charge and discharge states, the cells were opened and rinsed with DI water inside a glove box.

### REFERENCES

(1) Dunn, B.; Kamath, H.; Tarascon, J.-M. Electrical Energy Storage for the Grid: A Battery of Choices. Science 2011, 334, 928-935.
(2) Yang, Z.; Zhang, J.; Kintner-Meyer, M. C. W.; Lu, X.; Choi, D.; Lemmon, J. P.; Liu, J. Electrochemical Energy Storage for Green Grid. Chem. Rev. 2011, 111, 3577-3613.
(3) Larcher, D.; Tarascon, J. M. Towards Greener and More Sustainable Batteries for Electrical Energy Storage. Nat. Chem. 2015, 7, 19-29.
(4) Li, W.; Dahn, J. R.; Wainwright, D. S. Rechargeable Lithium Batteries with Aqueous Electrolytes. Science 1994, 264, 1115-1118.
(5) Luo, J.-Y.; Cui, W.-J.; He, P.; Xia, Y.-Y. Raising the Cycling Stability of Aqueous Lithium-Ion Batteries by Eliminating Oxygen in the Electrolyte. Nat. Chem. 2010, 2, 760-765.
(6) Kundu, D.; Adams, B. D.; Duffort, V.; Vajargah, S. H.; Nazar, L. F. A High-Capacity and Long-Life Aqueous Rechargeable Zinc Battery Using a Metal Oxide Intercalation Cathode. Nat. Energy 2016, 1, 16119.
(7) Pan, H.; Shao, Y.; Yan, P.; Cheng, Y.; Han, K. S.; Nie, Z.; Wang, C.; Yang, J.; Li, X.; Bhattacharya, P.; Mueller, K. T.; Liu, J. Reversible Aqueous Zinc/Manganese Oxide Energy Storage from Conversion Reactions. Nat. Energy 2016, 1, 16039.
(8) Zhang, N.; Cheng, F.; Liu, J.; Wang, L.; Long, X.; Liu, X.; Li, F.; Chen, J. Rechargeable Aqueous Zinc-Manganese Dioxide Batteries with High Energy and Power Densities. Nat. Commun. 2017, 8, 405.
(9) Hu, E.; Yang, X.-Q. Rejuvenating Zinc Batteries. Nat. Mater. 2018, 17, 480-481.
(10) Wang, F.; Borodin, O.; Gao, T.; Fan, X.; Sun, W.; Han, F.; Faraone, A.; Dura, J. A.; Xu, K.; Wang, C. Highly Reversible Zinc Metal Anode for Aqueous Batteries. Nat. Mater. 2018, 17, 543-549.
(11) Zhao, Q.; Huang, W.; Luo, Z.; Liu, L.; Lu, Y.; Li, Y.; Li, L.; Hu, J.; Ma, H.; Chen, J. High-Capacity Aqueous Zinc Batteries Using Sustainable Quinone Electrodes. Sci. Adv. 2018, 4, eaao1761.
(12) Xu, C.; Li, B.; Du, H.; Kang, F. Energetic Zinc Ion Chemistry: The Rechargeable Zinc Ion Battery. Angew. Chem. Int. Ed. 2012, 51, 933-935.
(13) Nam, K. W.; Kim, H.; Choi, J. H.; Choi, J. W. Crystal Water for High Performance Layered Manganese Oxide Cathodes in Aqueous Rechargeable Zinc Batteries. Energy Environ. Sci. 2019, 12, 1999-2009.
(14) Xia, C.; Guo, J.; Li, P.; Zhang, X.; Alshareef, H. N. Highly Stable Aqueous Zinc-Ion Storage Using a Layered Calcium Vanadium Oxide Bronze Cathode. Angew. Chem. Int. Ed. 2018, 57, 3943-3948.
(15) Lee, B.; Yoon, C. S.; Lee, H. R.; Chung, K. Y.; Cho, B. W.; Oh, S. H. Electrochemically-Induced Reversible Transition from the Tunneled to Layered Polymorphs of Manganese Dioxide. Sci. Rep. 2014, 4, 6066.
(16) Lee, B.; Lee, H. R.; Kim, H.; Chung, K. Y.; Cho, B. W.; Oh, S. H. Elucidating the Intercalation Mechanism of Zinc Ions into [symbol] —MnO₂ for Rechargeable Zinc Batteries. Chem. Commun. 2015, 51, 9265-9268.
(17) Kundu, D.; Oberholzer, P.; Glaros, C.; Bouzid, A.; Tervoort, E.; Pasquarello, A.; Niederberger, M. Organic Cathode for Aqueous Zn-ion Batteries: Taming a Unique Phase Evolution toward Stable Electrochemical Cycling. Chem. Mater. 2018, 30, 3874-3881.
(18) Kim, D. J.; Yoo, D.-J.; Otley, M. T.; Prokofjevs, A.; Pezzato, C.; Owczarek, M.; Lee, S. J.; Choi, J. W.; Stoddart, J. F. Rechargeable Aluminium Organic Batteries. Nat. Energy 2019, 4, 51-59.
(19) Liang, Y.; Jing, Y.; Gheytani, S.; Lee, K.-Y.; Liu, P.; Facchetti, A.; Yao, Y. Universal Quinone Electrodes for Long Cycle Life Aqueous Rechargeable Batteries. Nat. Mater. 2017, 16, 841.
(20) Dawut, G.; Lu, Y.; Miao, L.; Chen, J. High-Performance Rechargeable Aqueous Zn-ion Batteries with a Poly(Benzoquinonyl Sulfide) Cathode. Inorg. Chem. Front. 2018, 5, 1391-1396.
(21) Kim, D. J.; Hermann, K. R.; Prokofjevs, A.; Otley, M. T.; Pezzato, C.; Owczarek, M.; Stoddart, J. F. Redox-Active Macrocycles for Organic Rechargeable Batteries. J. Am. Chem. Soc. 2017, 139, 6635-6643 .
(22) Nalluri, S. K. M.; Liu, Z.; Wu, Y.; Hermann, K. R.; Samanta, A.; Kim, D. J.; Krzyaniak, M. D.; Wasielewski, M. R.; Stoddart, J. F. Chiral Redox-Active Isosceles Triangles. J. Am. Chem. Soc. 2016, 138, 5968-5977.
(23) Cao, L. L.; Bamford, K. L.; Liu, L. L.; Stephan, D. W. Zinc-Containing Radical Anions Via Single Electron Transfer to Donor-Acceptor Adducts. Chem-Eur. J. 2018, 24, 3980-3983.
(24) Nam, K. W.; Kim, S.; Lee, S.; Salama, M.; Shterenberg, I.; Gofer, Y.; Kim, J.-S.; Yang, E.; Park, C. S.; Kim, J.-S.; Lee, S.-S.; Chang, W.-S.; Doo, S.-G.; Jo, Y. N.; Jung, Y.; Aurbach, D.; Choi, J. W. The High Performance of Crystal Water Containing Manganese Birnessite Cathodes for Magnesium Batteries. Nano Lett. 2015, 15, 4071-4079.
(25) Mizuno, Y.; Okubo, M.; Hosono, E.; Kudo, T.; Zhou, H.; Oh-ishi, K. Suppressed Activation Energy for Interfacial Charge Transfer of a Prussian Blue Analog Thin Film Electrode with Hydrated Ions (Li⁺, Na⁺, and Mg²⁺). J. Phys. Chem. C 2013, 117, 10877-10882.
(26) Zhang, J.; Wang, X.; Su, Q.; Zhi, L.; Thomas, A.; Feng, X.; Su, D. S.; Schlögl, R.; Müllen, K. Metal-Free Phenanthrenequinone Cyclotrimer as an Effective Heterogeneous Catalyst. J. Am. Chem. Soc. 2009, 131, 11296-11297.
(27) Zhang, N.; Cheng, F.; Liu, Y.; Zhao, Q.; Lei, K.; Chen, C.; Liu, X.; Chen, J. Cation-Deficient Spinel ZnMn₂O₄ Cathode in Zn(CF₃SO₃)₂ Electrolyte for Rechargeable Aqueous Zn-ion Battery. J. Am. Chem. Soc. 2016, 138, 12894-12901.
(28) Novák, P.; Desilvestro, J. Electrochemical Insertion of Magnesium in Metal Oxides and Sulfides from Aprotic Electrolytes. J. Electrochem. Soc. 1993, 140, 140-144.
(29) Kim, S.; Nam, K. W.; Lee, S.; Cho, W.; Kim, J.-S.; Kim, B. G.; Oshima, Y.; Kim, J.-S.; Doo, S.-G.; Chang, H.; Aurbach, D.; Choi, J. W. Direct Observation of an Anomalous Spinel-to-Layered Phase Transition Mediated by Crystal Water Intercalation. Angew. Chem. Int. Ed. 2015, 54, 15094-15099.
(30) Aronson, B. J.; Kinser, A. K.; Passerini, S.; Smyrl, W. H.; Stein, A. Synthesis, Characterization, and Electrochemical Properties of Magnesium Birnessite and Zinc Chalcophanite Prepared by a Low-temperature Route. Chem. Mater. 1999, 11, 949-957.
(31) Yang, X.; Makita, Y.; Liu, Z.-h.; Sakane, K.; Ooi, K. Structural Characterization of Self-Assembled MnO₂ Nanosheets from Birnessite Manganese Oxide Single Crystals. Chem. Mater. 2004, 16, 5581-5588.
(32) Becke, A. D. Density-functional Thermochemistry. III. The Role of Exact Exchange. J. Chem. Phys. 2004, 98, 5648-5652.
(33) Shao, Y.; Molnar, L. F.; Jung, Y.; Kussmann, J.; Ochsenfeld, C.; Brown, S. T.; Gilbert, A. T. B.; Slipchenko, L. V.; Levchenko, S. V.; O’Neill, D. P.; DiStasio Jr, R. A.; Lochan, R. C.; Wang, T.; Beran, G. J. O.; Besley, N. A.; Herbert, J. M.; Yeh Lin, C.; Van Voorhis, T.; Hung Chien, S.; Sodt, A.; Steele, R. P.; Rassolov, V. A.; Maslen, P. E.; Korambath, P. P.; Adamson, R. D.; Austin, B.; Baker, J.; Byrd, E. F. C.; Dachsel, H.; Doerksen, R. J.; Dreuw, A.; Dunietz, B. D.; Dutoi, A. D.; Furlani, T. R.; Gwaltney, S. R.; Heyden, A.; Hirata, S.; Hsu, C.-P.; Kedziora, G.; Khalliulin, R. Z.; Klunzinger, P.; Lee, A. M.; Lee, M. S.; Liang, W.; Lotan, I.; Nair, N.; Peters, B.; Proynov, E. I.; Pieniazek, P. A.; Min Rhee, Y.; Ritchie, J.; Rosta, E.; David Sherrill, C.; Simmonett, A. C.; Subotnik, J. E.; Lee Woodcock Iii, H.; Zhang, W.; Bell, A. T.; Chakraborty, A. K.; Chipman, D. M.; Keil, F. J.; Warshel, A.; Hehre, W. J.; Schaefer Iii, H. F.; Kong, J.; Krylov, A. I.; Gill, P. M. W.; Head-Gordon, M. Advances in Methods and Algorithms in a Modern Quantum Chemistry Program Package. Phys. Chem. Chem. Phys. 2006, 8, 3172-3191.
(34) Marenich, A. V.; Olson, R. M.; Kelly, C. P.; Cramer, C. J.; Truhlar, D. G. Self-Consistent Reaction Field Model for Aqueous and Nonaqueous Solutions Based on Accurate Polarized Partial Charges. J. Chem. Theory Comput. 2007, 3, 2011-2033.
(35) Glendening, E. D.; Landis, C. R.; Weinhold, F. NBO 6.0: Natural Bond Orbital Analysis Program. J. Comput. Chem. 2013, 34, 1429-1437.

1. A cathodic material comprising a macrocycle, the macrocycle comprising a substituted or unsubstituted phenanthrenequinone unit and a zinc complex.

2. The cathodic material of claim 1, wherein the macrocycle comprises a hydrated zinc complex.

3. The cathodic material ofclaim 1, wherein the macrocycle comprises 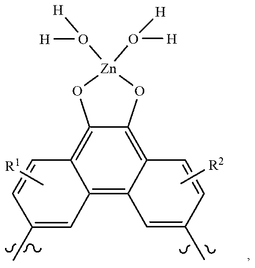
wherein R
¹ and R² are independently selected from hydrogen, halogen, azide, alkyl, aralkyl, alkenyl, alkynyl, cycloalkyl, hydroxyl, alkoxyl, amino, nitro, imino, amido, carbonyl, -C(O)alkyl, carboxy, -CO₂alkyl, alkylthio, sulfonyl, sulfonamido, sulfhydryl, sulfonamide, heterocyclyl, aryl, heteroaryl, —CF₃, or —CN.

4. The cathodic material of claim 3, wherein the macrocycle comprises three substituted or unsubstituted phenanthrenequinone units in a triangular arrangement.

5. The cathodic material of claim 4, wherein the macrocycle comprises.

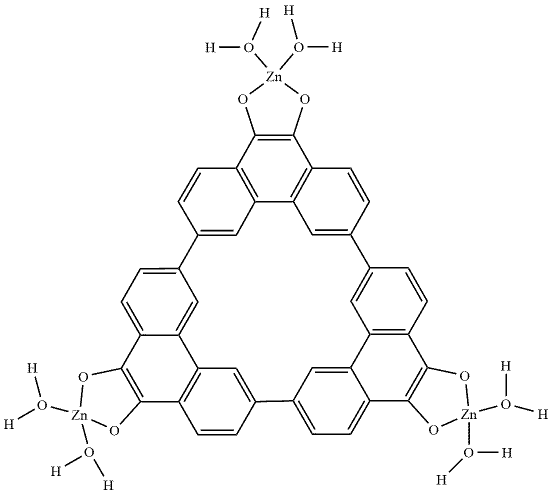

6. The cathodic material of claim1, wherein the macrocycle is planar.

7. The cathodic material of claim 1, wherein the cathodic material further comprises an electron-conducting additive.

8. The cathodic material of claim 7, wherein the electron-conducting additive is acetylene black.

9. The cathodic material of claim 1, wherein the cathodic material comprises a binder material.

10. The cathodic material of claim 9, wherein the binder material is PVDF.

11. An electrode comprising the cathodic material of claim 1 and a substrate.

12. A battery comprising a cathode, the cathode comprising a macrocycle, the macrocycle comprising a substituted or unsubstituted phenanthrenequinone unit, and an aqueous zinc electrolyte.

13. The battery of claim 12, wherein the macrocycle comprises 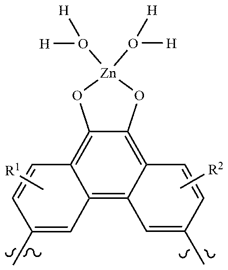
or 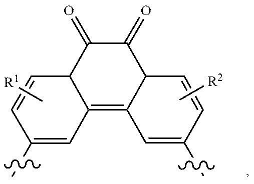
wherein R
¹ and R² are independently selected from hydrogen, halogen, azide, alkyl, aralkyl, alkenyl, alkynyl, cycloalkyl, hydroxyl, alkoxyl, amino, nitro, imino, amido, carbonyl, -C(O)alkyl, carboxy, -CO₂alkyl, alkylthio, sulfonyl, sulfonamido, sulfhydryl, sulfonamide, heterocyclyl, aryl, heteroaryl, —CF₃, or —CN.

14. The battery of claim 12, wherein the macrocycle comprises three substituted or unsubstituted phenanthrenequinone units in a triangular arrangement.

15. The battery of claim 14, wherein the macrocycle comprises 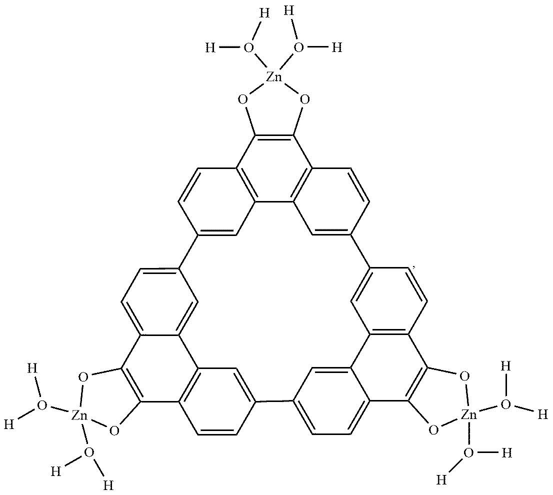
.

16. The battery of claim 14, wherein the macrocycle comprises 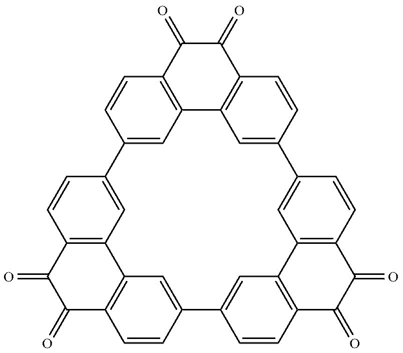 [SMILES: O=c1c(=O)c2ccc3cc2c2cc(ccc12)c1ccc2c(=O)c(=O)c4ccc(cc4c2c1)c1ccc2c(=O)c(=O)c4ccc3cc4c2c1]
.

17. The battery of claim 12, wherein the macrocycle is planar.

18. The battery of claim 12, wherein the cathode further comprises an electron-conducting additive.

19. (canceled)

20. The battery of claim 12, wherein the cathode comprises a binder material.

21. (canceled)

22. The battery of claim 12, wherein the electrolyte comprises Zn(CF₃SO₃)₂, Zn(CH₃SO₃)₂, ZnSO₄xH₂O where x = 0-7, Zn(NO₃)₂•xH₂O where x = 0-6, or Zn(TFSI)₂.

23. The battery of claim 12, wherein the concentration of Zn²⁺ in the aqueous zinc electrolyte is less than 6.0 M.
